(19) United States
(12) Patent Application Publication
(10) Pub. No.: US 2022/0269898 A1
(43) Pub. Date: Aug. 25, 2022

(54) INFORMATION PROCESSING DEVICE, INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventors: Shusaku KUBO, Kanagawa (JP); Kunihiko KOBAYASHI, Kanagawa (JP); Shigeru OKADA, Kanagawa (JP); Fumi KOSAKA, Kanagawa (JP); Jun ANDO, Kanagawa (JP); Masanori YOSHIZUKA, Kanagawa (JP); Yusuke SUZUKI, Kanagawa (JP); Masayuki YAMAGUCHI, Kanagawa (JP)

(73) Assignee: FUJIFILM Business Innovation Corp., Tokyo (JP)

(21) Appl. No.: 17/400,625

(22) Filed: Aug. 12, 2021

(30) Foreign Application Priority Data
Feb. 22, 2021 (JP) 2021-026598

(51) Int. Cl. G06K 9/54; G06K 9/00; G06K 9/62; G06K 9/34

(52) U.S. Cl. CPC G06K 9/54; G06K 9/00469; G06K 9/00456; G06K 9/6217; G06K 9/346; G06K 2209/01

(57) ABSTRACT

An information processing device includes: a processor configured to: execute, as preprocessing prior to character recognition, image conversion processing for a document that is a target of the character recognition, the image conversion processing having been determined in advance for each of attributes in the document or for each of regions in the document, the regions having been determined in advance according to a document type; and execute processing of executing the character recognition for the document that has been subjected to the image conversion processing to output a result of the character recognition.

### CROSS-REFERENCE TO RELATED APPLICATIONS

This application is based on and claims priority under 35 USC 119 from Japanese Patent Application No. 2021-026598 filed Feb. 22, 2021.

### BACKGROUND

### (i) Technical Field

The present disclosure relates to an information processing device, an information processing system, an information processing method, and a non-transitory computer readable medium.

### (ii) Related Art

JP-A-2019-82814 discloses an image analysis device that extracts character information from a target image. The image analysis device includes an ORC engine configured to learn with an OCR engine learning device including a learning image generator configured to generate a learning image by executing learning image conversion on a character of a specific font, a learning image generation learning unit configured to cause the learning image generator to learn the learning image conversion for converting a second image into a first image using a set of the first image including a recognized character and the second image representing the recognized character with the specific font, and a character recognition learning unit configured to cause the OCR engine to learn extraction of the character from the image using a set of the learning image generated by the learning image generator and the character corresponding to the learning image, and an OCR unit configured to extract the character information from the target image using the OCR engine.

Japanese Patent No. 6237369 discloses an image forming device configured to execute appropriate preprocessing when an application provided by an external apparatus is used. Specifically, the image forming device determines the preprocessing according to the external application, and registers the determined preprocessing in a memory. Then, when image processing using the external application is instructed, data on which the preprocessing registered in the memory corresponding to the external application is executed is passed to the external application. Further, when the preprocessing is determined, the image forming device executes first image processing for first image data to generate second image data, passes the second image data to the external application, and receives processed data from the external application. Then, based on the second image data and the processed data, the image forming device determines whether the first image processing is the preprocessing corresponding to the external application.

### SUMMARY

Aspects of non-limiting embodiments of the present disclosure relate to an information processing device, an information processing system, an information processing method, and a non-transitory computer readable medium capable of achieving both a processing speed and character recognition accuracy as compared to a case where single image conversion processing is uniformly executed for an entire document as preprocessing prior to character recognition.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device including: a processor configured to: execute, as preprocessing prior to character recognition, image conversion processing for a document that is a target of the character recognition, the image conversion processing having been determined in advance for each of attributes in the document or for each of regions in the document, the regions having been determined in advance according to a document type; and execute processing of executing the character recognition for the document that has been subjected to the image conversion processing to output a result of the character recognition.

### BRIEF DESCRIPTION OF THE DRAWINGS

Exemplary embodiment(s) of the present disclosure will be described in detail based on the following figures, wherein:

FIG. 1 illustrates a schematic configuration of an information processing system according to an exemplary embodiment;

FIG. 2 is a block diagram illustrating a configuration of an electrical system of an image forming device in the information processing system according to the exemplary embodiment;

FIG. 3 is a block diagram illustrating a configuration of an electrical system of a server, a mobile terminal, and a client terminal in the information processing system according to the exemplary embodiment;

FIG. 4 illustrates extraction of attributes in a document that has been subjected to character recognition processing;

FIG. 5 is a functional block diagram illustrating a functional configuration of the server in the information processing system according to the exemplary embodiment;

FIG. 6 illustrates an example of a list that defines, for each document type, important words to be acquired, processing contents of preprocessing, and processing positions of the preprocessing, in advance;

FIG. 7 is a flowchart of an example of processing executed by the server of the information processing system according to the present exemplary embodiment;

FIG. 8 illustrates an example of a list that defines, for each document type, important words to be acquired, processing contents of preprocessing, and a processing order, in advance;

FIG. 9 illustrates an example in which the processing order is changed and the preprocessing is executed; and

FIG. 10 is a flowchart of an example of processing when the server of the information processing system according to the exemplary embodiment changes a page order of a contract and executes the preprocessing.

### DETAILED DESCRIPTION

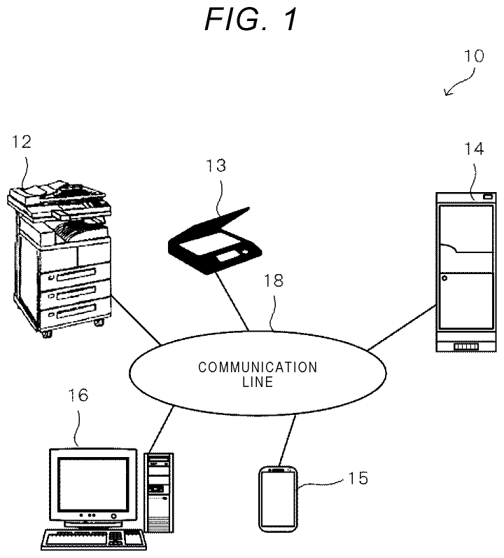

Hereinafter, an example of an exemplary embodiment according to the present disclosure will be described in detail with reference to the drawings. FIG. 1 illustrates a schematic configuration of an information processing system according to the present exemplary embodiment.

As illustrated in FIG. 1, an information processing system 10 according to the present exemplary embodiment includes an image forming device 12, a scanner device 13, a server 14 as an information processing device, a mobile terminal 15, and a client terminal 16. In the present exemplary embodiment, one image forming device 12, one scanner device 13, one server 14, one mobile terminal 15, and one client terminal 16 are provided. Alternatively, the number of each of the image forming device 12, the scanner device 13, the server 14, the mobile terminal 15, and the client terminal 16 may be two or more. The image forming device 12, the scanner device 13, the mobile terminal 15, and the client terminal 16 correspond to examples of a request device. At least one of them may be left and the others may be omitted. Further, as the client terminal 16, for example, a personal computer is applied as an example, and as the mobile terminal 15, a mobile terminal such as a tablet terminal or a smartphone is applied.

The image forming device 12, the scanner device 13, the server 14, the mobile terminal 15, and the client terminal 16 are connected to each other via a communication line 18 such as a local area network (LAN), a wide area network (WAN), the Internet, and an intranet. Then, the image forming device 12, the scanner device 13, the server 14, the mobile terminal 15, and the client terminal 16 can transmit and receive various data to and from each other via the communication line 18.

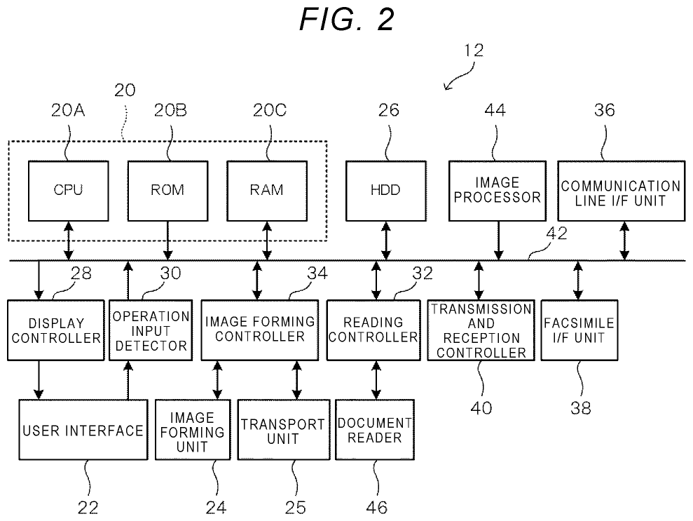

FIG. 2 is a block diagram illustrating a configuration of an electrical system of the image forming device 12 in the information processing system 10 according to the present exemplary embodiment.

As illustrated in FIG. 2, the image forming device 12 according to the present exemplary embodiment includes a control unit 20 including a central processing unit (CPU) 20A, a read only memory (ROM) 20B, and a random-access memory (RAM) 20C. The CPU 20A controls an overall operation of the image forming device 12. The RAM 20C is used as a work area when the CPU 20A executes various programs. The ROM 20B stores various control programs, various parameters, and the like in advance. Then, in the image forming device 12, the respective elements of the control unit 20 are electrically connected to each other by a system bus 42.

The image forming device 12 according to the present exemplary embodiment includes a hard disk drive (HDD) 26 that stores various data, application programs, and the like. The image forming device 12 includes a display controller 28 that is connected to a user interface 22 and controls display of various operation screens on a display of the user interface 22. The image forming device 12 includes an operation input detector 30 that is connected to the user interface 22 and detects an operation instruction input via the user interface 22. Further, in the image forming device 12, the HDD 26, the display controller 28, and the operation input detector 30 are electrically connected to the system bus 42. The present exemplary embodiment will describe the example in which the image forming device 12 includes the HDD 26. The present disclosure is not limited to this example. The image forming device 12 may include a non-volatile storage such as a flash memory.

The image forming device 12 according to the present exemplary embodiment includes a reading controller 32 that controls an optical image reading operation by a document reader 46 and a document feeding operation by a document feeder, and an image forming controller 34 that controls image forming processing by an image forming unit 24 and transport of a sheet to the image forming unit 24 by a transport unit 25. The image forming device 12 includes a communication line interface (communication line I/F) unit 36 that is connected to the communication line 18 and transmits and receives communication data to and from other external devices such as the server 14 connected to the communication line 18, and an image processor 44 that performs various types of image processing. The image forming device 12 includes a facsimile interface (facsimile I/F) unit 38 that is connected to a telephone line (not illustrated) and transmits and receives facsimile data to and from a facsimile device connected to the telephone line. The image forming device 12 includes a transmission and reception controller 40 that controls the transmission and reception of the facsimile data via the facsimile interface unit 38. Then, in the image forming device 12, the transmission and reception controller 40, the reading controller 32, the image forming controller 34, the communication line interface unit 36, the facsimile interface unit 38, and the image processor 44 are electrically connected to the system bus 42.

With the above configuration, the image forming device 12 according to the present exemplary embodiment causes the CPU 20A to access the RAM 20C, the ROM 20B, and the HDD 26. The image forming device 12 executes control, by the CPU 20A, of displaying of information such as the operation screen and various messages) on the display of the user interface 22 via the display controller 28. The image forming device 12 executes control, by the CPU 20A, of operations of the document reader 46 and the document transport unit via the reading controller 32. The image forming device 12 executes control of operations of the image forming unit 24 and the transport unit 25 via the image forming controller 34, and controls of the transmission and reception of the communication data via the communication line interface unit 36, by the CPU 20A. The image forming device 12 executes control, by the CPU 20A, of the transmission and reception of the facsimile data by the transmission and reception controller 40 via the facsimile interface unit 38. Further, the image forming device 12 grasps contents of an operation performed on the user interface 22 based on operation information detected by the operation input detector 30, and executes various types of controls based on the operation content, by the CPU 20A.

The scanner device 13 has similar configurations as those of the control unit 20, the reading controller 32, and the document reader 46 of the image forming device 12. Since a basic configuration thereof is similar, a detailed description thereof will be omitted.

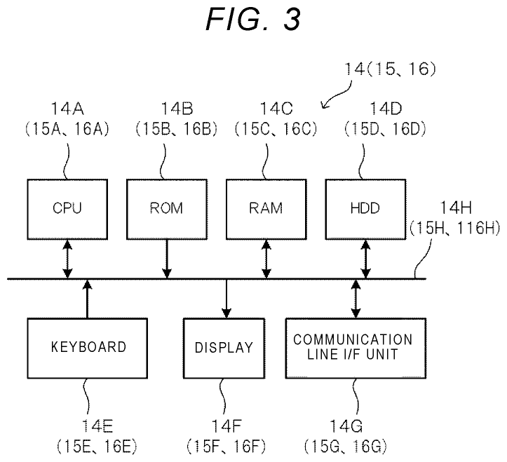

Next, a configuration of an electrical system of the server 14, the mobile terminal 15, and the client terminal 16 according to the present exemplary embodiment will be described. FIG. 3 is a block diagram illustrating the configuration of the electrical system of the server 14, the mobile terminal 15, and the client terminal 16 in the information processing system 10 according to the present exemplary embodiment. Since the server 14, the mobile terminal 15, and the client terminal 16 is basically implemented by a general-purpose computer, the server 14 will be described as a representative. For the mobile terminal 15 and the client terminal 16, corresponding reference signs are simply denoted, and a detailed description thereof will be omitted.

As illustrated in FIG. 3, the server 14 according to the present exemplary embodiment includes a CPU 14A, a ROM 14B, a RAM 14C, an HDD 14D, a keyboard 14E, a display 14F, and a communication line interface (I/F) unit 14G. The CPU 14A controls an overall operation of the server 14. The ROM 14B stores various control programs, various parameters, and the like in advance. The RAM 14C is used as a work area when the CPU 14A executes various programs. The HDD 14D stores various data, application programs, and the like. The keyboard 14E is used to input various information. The display 14F is used to display various information. The communication line interface unit 14G is connected to the communication line 18, and transmits and receives various data to and from other devices connected to the communication line 18. The respective units of the server 14 are electrically connected to one another by a system bus 14H. The present exemplary embodiment will describe an example in which the server 14 according includes the HDD 14D. The present disclosure is not limited to this example. The server 14 may include another non-volatile storage such as the flash memory.

With the above configuration, the server 14 according to the present exemplary embodiment causes the CPU 14A to access the ROM 14B, the RAM 14C, and the HDD 14D, acquire various data via the keyboard 14E, and display various information on the display 14F. Further, the server 14 executes control, by the CPU 14A, of the transmission and reception of the communication data via the communication line interface unit 14G.

In general, for document management in a company, documents are classified by document type, company name, contract date, estimate date, and the like, and are often arranged in, for example, folders for management. When contents of documents are centrally managed, document names, the company names, main service names, dates, and the like are often separately transcribed to spreadsheet software such that a list of the transcribed information can be viewed. However, in order to execute such a list management, it is necessary to bring files, open a target file, search for a location where contents of interest are described, and transcribe the content while viewing the content.

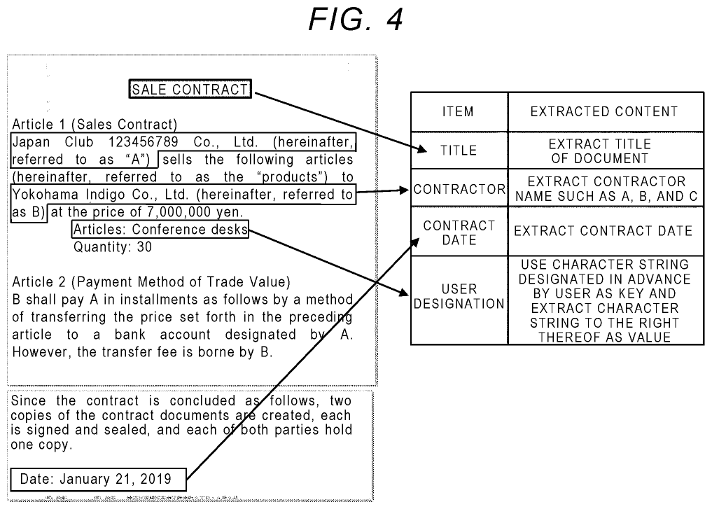

Then, in order to acquire necessary information by reading documents and executing optical character recognition (OCR) processing, in the information processing system 10 according to the present exemplary embodiment configured as described above, the server 14 executes character recognition processing for recognizing characters of various documents to extract attributes in the documents. For example, as illustrated in FIG. 4, items such as a title, contractors, a contract date, and a user designation item are extracted as the attributes in a document from the document that has been subjected to character recognition processing. For the title, a word such as a contract is used as a key, and the title is extracted as a value. For the contractors, contractor names such as A, B, and C are extracted as values. For the contract date, the contract date is extracted by pattern matching. For the user designation item, a character string designated in advance by a user is used as a key, and a character string that is to the right of the designated character string is extracted as a value.

However, it may be difficult to recognize a character string that is to be used as a key of the document to be acquired because of a situation such as a background. For example, in documents such as a contract, an estimate, and a bill, it may be difficult to recognize a character string due to overlapping of an imprint and a character. In documents such as an estimate and a bill, it may be difficult to recognize a character string due to a halftone dot used in a table. In a certificate, it may be difficult to recognize to a character string due to a ground pattern. Further, in a facsimile, it may be difficult to recognize a character string due to a low resolution. Among these processing, in recent years, by executing image conversion processing by AI (artificial intelligence) processing using artificial intelligence that has been trained in advance by machine learning as preprocessing, processing of removing an image other than characters to generate an image that is easy to be character-recognized may be executed. However, the processing takes very long time, which forces the user to wait.

Therefore, in the present exemplary embodiment, the server 14 executes, as the preprocessing prior to the character recognition, the predetermined image conversion processing for a document that is a target of the character recognition, the image conversion processing having been determined in advance for each of attributes in the document or for each of regions in the document, the regions having been determined in advance according to a document type. The server 14 executes processing of executing the character recognition for the document which has been subjected to the image conversion processing to output a result of the character recognition. Hereinafter, as an example of executing the predetermined image conversion processing that has been determined in advance for each of the attributes in the document, an example in which the image conversion processing is switched and executed in units of pages will be described.

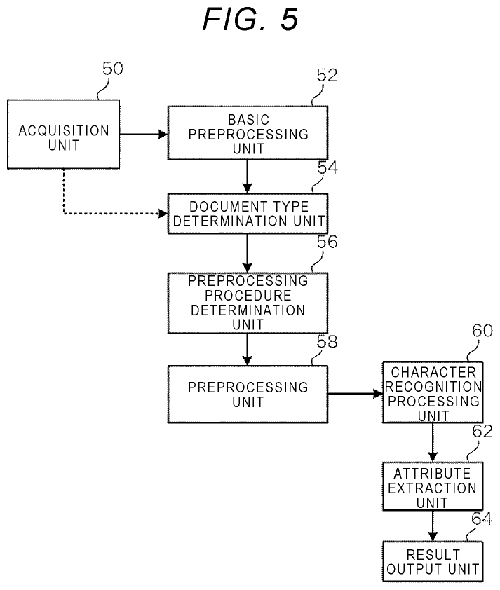

Here, a functional configuration implemented by the CPU 14A of the server 14 executing the program stored in the ROM 14B will be described. FIG. 5 is a functional block diagram illustrating the functional configuration of the server 14 in the information processing system 10 according to the present exemplary embodiment.

As illustrated in FIG. 5, the server 14 according to the present exemplary embodiment has functions of an acquisition unit 50, a basic preprocessing unit 52, a document type determination unit 54, a preprocessing procedure determination unit 56, a preprocessing unit 58, a character recognition processing unit 60, an attribute extraction unit 62, and a result output unit 64.

The acquisition unit 50 acquires document information from the image forming device 12, the scanner device 13, the mobile terminal 15, or the client terminal 16. In a case of a paper document, the document information generated by reading the paper document by the image forming device 12 or the scanner device 13 is acquired.

The basic preprocessing unit 52 executes detection of a top and a bottom of the document, inclination correction, specification of the document, and the like as basic preprocessing. As the specification of the document, for example, the basic preprocessing unit 52 may specify the document type by executing the character recognition on a first page of the document information in a simplified manner to detect the title, or may prompt a user to input the document type and receive the input document type.

When the basic preprocessing unit 52 executes the character recognition in a simplified manner to specify the document, the document type determination unit 54 determines the document type based on the document specified by the basic preprocessing unit 52. Further, when the user is asked to input the document type, the acquisition unit 50 acquires the document information, receives the input information, and determines the document type based on the received information.

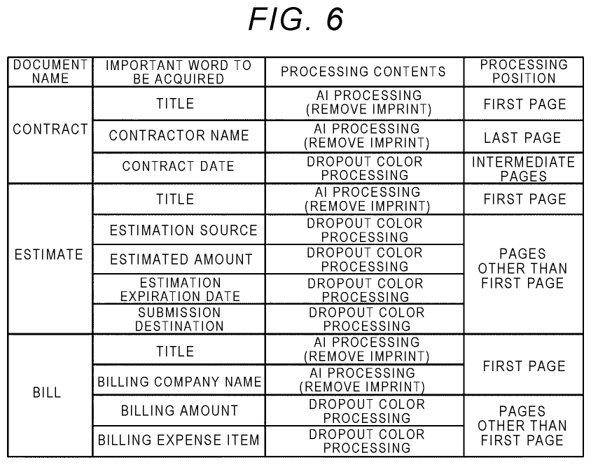

The preprocessing procedure determination unit 56 acquires information on (i) an attribute to be acquired, (ii) the preprocessing in acquiring the attribute in the document, and (iii) a procedure of the processing, which are defined in advance according to the document type, and determines a procedure of the preprocessing. The preprocessing procedure determination unit 56 determines the procedure of the preprocessing using, for example, a list that defines, for each document type, the attribute to be acquired such as an item to be acquired, the preprocessing in acquiring the attribute in the document, and a processing position. Specifically, as in a list illustrated in FIG. 6, important words (as the attributes to be acquired), processing contents of the preprocessing, and the processing positions are defined in advance for each document name, and corresponding contents are determined according to the document type. FIG. 6 illustrates an example of the list that defines, for each document type, the important words to be acquired, the processing contents of the preprocessing, and the processing positions of the preprocessing, in advance. In the example of FIG. 6, for the title of the contract, the processing contents are AI processing for removing an imprint and the processing position is the first page; for the contractor name of the contract, the processing contents are the AI processing for removing an imprint and the processing position is the last page; and for the contract date of the contract, the processing contents are dropout color processing and the processing position is an intermediate page. For the title of the estimate; the processing contents are the AI processing for removing an imprint, and the processing position is the first page; and for an estimation source, an estimated amount, an estimation expiration date, and a submission destination of the estimate, the processing contents are the dropout color processing and the processing positions are pages other than the first page. Further, for a title and a billing company name of a bill, the processing contents are the AI processing for removing an imprint and the processing positions are the first page; and for a billing amount and a billing expense item of the bill, the processing contents are the dropout color processing and the processing positions are pages other than the first page.

The preprocessing unit 58 executes the preprocessing for the document information according to a determination result of the preprocessing procedure determination unit 56. In the present exemplary embodiment, the preprocessing unit 58 executes the preprocessing determined by the preprocessing procedure determination unit 56 from among plural types of preprocessing. As an example of the plural types of preprocessing, the image conversion processing is executed, such as (i) plural types of AI processing as an example of first image conversion processing, (ii) the dropout color processing as an example of second image conversion processing, (iii) screen image density processing, and (iv) sharpness adjustment. The AI processing is processing of removing an image other than characters by executing image conversion in accordance with an image by artificial intelligence processing using a machine-learned artificial intelligence model. The AI processing includes plural types of processing trained for each object to be removed other than characters. The dropout color processing is processing having lower character recognition accuracy and higher processing speed than the AI processing, and is processing of binarizing each color and removing an image of a desired color using a predetermined threshold. The screen image density processing is processing for adjusting a density of the image. The sharpness adjustment is processing for adjusting a degree of enhancement of a contour of an image.

The character recognition processing unit 60 recognizes characters based on the document information, which has subjected to the image conversion processing by the preprocessing unit 58, to generate character information. In the character recognition processing, the character recognition is executed by a known technique.

The attribute extraction unit 62 extracts attributes such as the items in the document based on the character information generated by the character recognition processing.

The result output unit 64 outputs an extraction result by the attribute extraction unit 62 to a requesting device. For example, the result output unit 64 outputs the extraction result to the image forming device 12, the scanner device 13, the mobile terminal 15, or the client terminal 16.

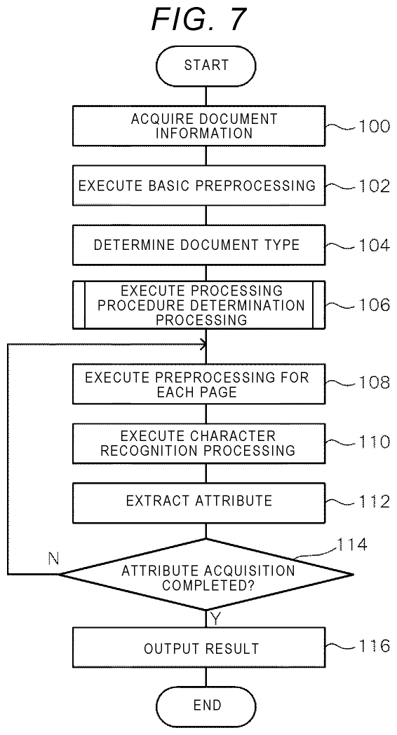

Next, specific processing executed by the server 14 of the information processing system 10 according to the present exemplary embodiment configured as described above will be described. FIG. 7 is a flowchart of an example of the processing executed by the server 14 of the information processing system 10 according to the present exemplary embodiment. The processing of FIG. 7 is started, for example, when the execution of the character recognition processing is instructed by the image forming device 12, the scanner device 13, the mobile terminal 15, or the client terminal 16.

In step 100, the CPU 14A acquires document information, and the process proceeds to step 102. That is, the acquisition unit 50 acquires the document information from the image forming device 12, the scanner device 13, the mobile terminal 15, or the client terminal 16. In a case of a paper document, the document information generated by reading a paper document by the image forming device 12 or the scanner device 13 is acquired.

In step 102, the CPU 14A executes the basic preprocessing for the acquired document information, and the process proceeds to step 104. That is, the basic preprocessing unit 52 executes the detection of the top and the bottom of a document, the inclination correction, the specification of the document, and the like as the basic preprocessing.

In step 104, the CPU 14A determines a document type, and the process proceeds to step 106. That is, when the basic preprocessing unit 52 specifies the document by executing the character recognition in a simplified manner, the document type determination unit 54 determines the document type based on the document specified by the basic preprocessing unit 52. When the user is asked to input the document type, the acquisition unit 50 acquires the document information, receives the input information, and determines the document type based on the received information.

In step 106, the CPU 14A executes processing procedure determination processing, and the process proceeds to step 108. In the processing procedure determination processing, the preprocessing procedure determination unit 56 determines a preprocessing procedure based on the list that defines, for each document type, the important words to be acquired, the processing contents of the preprocessing, and the processing positions of the preprocessing, in advance. For example, the processing procedure is determined based on the document type and the list illustrated in FIG. 6. Specifically, when the document type is a contract, for the first page having a title, the processing contents are set to the AI processing; for the last page having a contractor name, the processing contents are set to the AI processing; and for an intermediate page having a contract date the processing contents are set to the dropout color processing.

In step 108, the CPU 14A executes the preprocessing for each page, and the process proceeds to step 110. That is, the preprocessing unit 58 focuses on one page in accordance with the determination result by the preprocessing procedure determination unit 56 and executes the preprocessing for the document information. In the present exemplary embodiment, the preprocessing unit 58 executes the preprocessing determined by the preprocessing procedure determination unit 56 from among plural types of preprocessing. For example, when the document is a contract, the first page having a title and the last page having a contractor name are preprocessed by the AI processing for removing an imprint, and an intermediate page having a contract date between the first page and the last page are preprocessed by the dropout color processing.

In step 110, the CPU 14A executes the character recognition processing for the preprocessed page, and the process proceeds to step 112. That is, the character recognition processing unit 60 recognizes characters based on the document information preprocessed by the preprocessing unit 58 to generate character information.

In step 112, the CPU 14A extracts attributes based on the character information generated by the character recognition processing, and the process proceeds to step 114. That is, the attribute extraction unit 62 extracts the attributes such as items in the document based on the character information generated by the character recognition processing.

In step 114, the CPU 14A determines whether attribute acquisition is completed. Specifically, the CPU 14A determines whether there are remaining pages to be preprocessed and to be subjected to the character recognition processing. When the determination is negative, the process proceeds to step 108, and the above-described processing is repeated for the remaining pages. When the determination is affirmative, the process proceeds to step 116.

In step 116, the CPU 14A outputs a result of the attribute extraction, and ends a series of processing. That is, the result output unit 64 outputs the extraction result by the attribute extraction unit 62 to the requesting device. For example, the result output unit 64 outputs the extraction result to the image forming device 12, the scanner device 13, the mobile terminal 15, or the client terminal 16.

In this way, in the present exemplary embodiment, for example, the image conversion processing by the AI processing is executed as the preprocessing for the page in which the imprint is highly likely to overlap characters (for example, an attribute such as the title or the contractor name of the contract). On the other hand, for the other pages, the image conversion processing by the dropout color processing having the lower processing load and the higher processing speed than the AI processing is executed as the preprocessing. That is, by executing the image conversion processing which is the preprocessing determined in advance for each attribute in the document, both the processing speed and the character recognition accuracy are achieved as compared to a case where single image conversion processing is executed as the preprocessing.

In the exemplary embodiment described above, the example in which the preprocessing is sequentially executed without interchanging pages with each other has been described. Alternatively, the preprocessing may be executed by changing an order of pages to be processed.

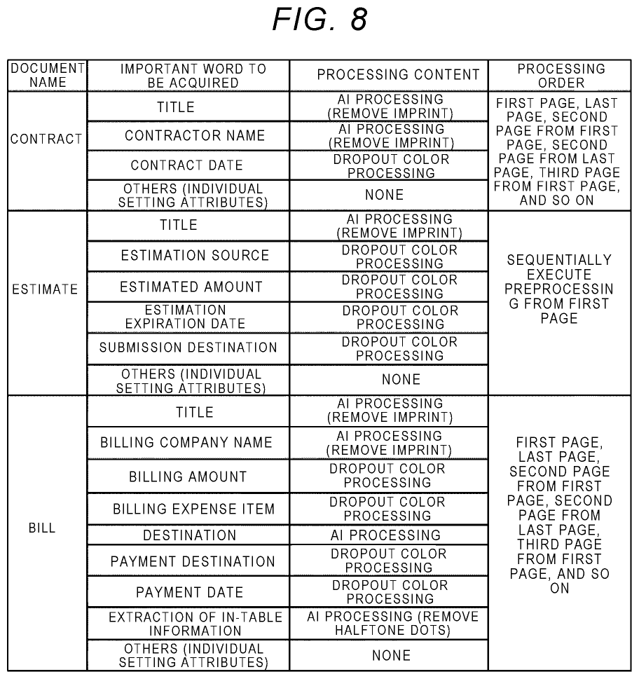

Here, a case where the preprocessing is executed with changing the page order will be described as a modification. In this case, as illustrated in FIG. 8, a list that defines the processing order in advance is used in place of the list of FIG. 6. FIG. 8 illustrates an example of a list that defines, for each document type, important words to be acquired, processing contents of the preprocessing, and the processing order, in advance. In the example of FIG. 8, for a title of a contract, the processing contents are the AI processing for removing an imprint; for a contractor name of the contract, the processing contents are the AI processing for removing an imprint; for a contract date of the contract, the processing contents are the dropout color processing; and for the others (individual setting attributes), no preprocessing is set. Then, the processing order is set to an order of a first page, a last page, a second page from the first page, a second page from the last page, a third page from the first page, and so on. Further, for a title of an estimate, the processing contents are the AI processing for removing an imprint; for an estimation source, an estimated amount, an estimation expiration date, and a submission destination of the estimate, the processing contents are the dropout color processing; and for the others (individual setting attributes), no preprocessing is set. Then, a processing order is set to an order in which the preprocessing is sequentially executed from the first page. Further, for a title and a billing company name of a bill, the processing contents are the AI processing for removing an imprint; for a billing amount, a billing expense item, a payment destination, and a payment date of the bill, the processing contents are the dropout color processing; for a destination of the bill, the processing contents are the AI processing; for extraction of in-table information of the bill, the processing contents are the AI processing for removing halftone dots; and for the others (individual setting attributes) of the bill, no preprocessing is set. Then, the processing order is set to an order of the first page, the last page, a second page from the first page, a second page from the last page, a third page from the first page, and so on.

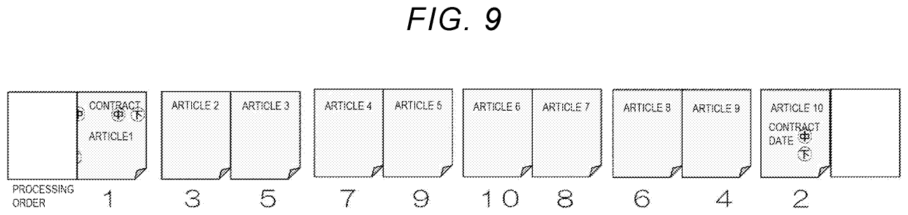

For example, when the document is the contract, as illustrated in FIG. 9, the same preprocessing is collectively executed by changing the processing order and executing the preprocessing. In an example of FIG. 9, the preprocessing is executed in an order of the first page of Article 1 in which an imprint may overlap a character, the last page of Article 10, a page of Article 2, a page of Article 9, a page of Article 3, a page of Article 8, a page of Article 4, a page of Article 7, a page of Article 5, and a page of Article 6.

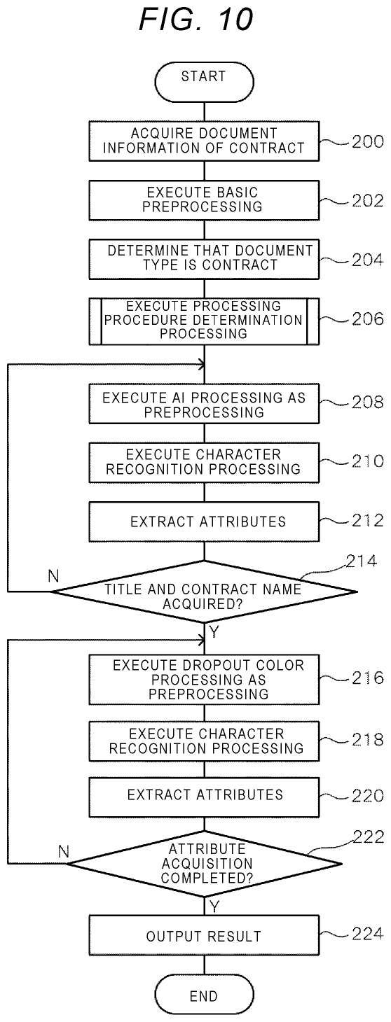

Next, specific processing executed by the server 14 of the information processing system 10 when the preprocessing is executed with changing the page order of the contract will be described. FIG. 10 is a flowchart of an example of processing when the server 14 of the information processing system 10 according to the present exemplary embodiment executes the preprocessing with changing the page order of the contract. The processing of FIG. 10 is started, for example, when execution of character recognition processing is instructed by the image forming device 12, the scanner device 13, the mobile terminal 15, or the client terminal 16.

In step 200, the CPU 14A acquires document information on the contract, and the process proceeds to step 202. That is, the acquisition unit 50 acquires the document information on the contract from the image forming device 12, the scanner device 13, the mobile terminal 15, or the client terminal 16. In a case of a paper document, the document information on the contract generated by reading the contract of the paper document by the image forming device 12 or the scanner device 13 is acquired.

In step 202, the CPU 14A executes basic preprocessing for the acquired document information on the contract, and the process proceeds to step 204. That is, the basic preprocessing unit 52 executes the detection of the top and the bottom of a document, the inclination correction, the specification of the document, and the like as the basic preprocessing.

In step 204, the CPU 14A determines that a document type is a contract, and the process proceeds to step 206. That is, when the basic preprocessing unit 52 executes the character recognition in a simplified manner to specify the document, the document type determination unit 54 determines that the document type is the contract based on the document specified by the basic preprocessing unit 52. When a user is asked to input the document type, the acquisition unit 50 acquires the document information, receives the input information, and determines that the document type is the contract based on the received information.

In step 206, the CPU 14A executes processing procedure determination processing, and the process proceeds to step 208. In the processing procedure determination processing, the preprocessing procedure determination unit 56 determines a preprocessing procedure based on the list that defines, for each document type, the important words to be acquired, the processing contents of the preprocessing, and the processing order of the preprocessing, in advance. For example, the processing procedure is determined based on the document type and the list illustrated in FIG. 8. Specifically, when the document type is the contract, for a page having the title and the contractor name, the processing contents are set to the AI processing; for a page having the contract date, the processing contents are set to the dropout color processing; and for pages having the others (individual setting attributes), no preprocessing is set, and the processing order is set to a processing order of the first page, the last page, the second page from the first page, the second page from the last page, the third page from the first page, and so on.

In step 208, the CPU 14A executes the AI processing as the preprocessing, and the process proceeds to step 210. That is, the preprocessing unit 58 executes the AI processing for each page according to the determination result by the preprocessing procedure determination unit 56. Here, the AI processing are executed for the first page having the title and the last page having the contractor name.

In step 210, the CPU 14A executes the character recognition processing for the preprocessed page, and the process proceeds to step 212. That is, the character recognition processing unit 60 recognizes characters based on the document information to generate character information for the first page and the last page, which have been preprocessed by the preprocessing unit 58.

In step 212, the CPU 14A extracts attributes based on the character information generated by the character recognition processing, and the process proceeds to step 214. That is, the attribute extraction unit 62 sequentially extracts the title and the contractor name as the attributes such as the items in the document based on the character information generated by the character recognition processing.

In step 214, the CPU 14A determines whether the title and the contractor name have been acquired. In this determination, it is determined whether the last contractor name has been extracted after the title was extracted from the first page. When only the title has been extracted but the contractor name has not been extracted, the determination is negative and the process returns to step 208 to repeat the above-described processing for a next page. When the determination is affirmative, the process proceeds to step 216.

In step 216, the CPU 14A executes the dropout color processing as the preprocessing, and the process proceeds to step 218. That is, the preprocessing unit 58 executes the dropout color processing for each page according to the determination result by the preprocessing procedure determination unit 56. Here, the dropout color processing is executed for the second page from the first page, the second page from the last page, the third page from the first page, and so on.

In step 218, the CPU 14A executes the character recognition processing for the preprocessed page, and the process proceeds to step 220. That is, the character recognition processing unit 60 recognizes characters based on the document information preprocessed by the preprocessing unit 58 to generate character information. Here, the character recognition processing is executed for the document information that has been subjected to the dropout color processing to generate the character information.

In step 220, the CPU 14A extracts attributes based on the character information generated by the character recognition processing, and the process proceeds to step 222. That is, the attribute extraction unit 62 extracts the contract date as the attribute such as the item in the document based on the character information generated by the character recognition processing.

In step 222, the CPU 14A determines whether the attribute acquisition has been completed. When the determination is negative, the process returns to step 216 to repeat the above-described processing. When the determination is affirmative, the process proceeds to step 224.

In step 224, the CPU 14A outputs a result of the attribute extraction, and ends a series of processing. That is, the result output unit 64 outputs the extraction result by the attribute extraction unit 62 to the requesting device. For example, the result output unit 64 outputs the extraction result to the image forming device 12, the scanner device 13, the mobile terminal 15, or the client terminal 16.

In the exemplary embodiment described above, the example in which the image conversion processing that has been determined in advance for each attribute in the document is executed in units of pages as the preprocessing has been described. The present disclosure is not limited to the units of pages. For example, when a position in a page where an attribute (such as a title of a contract) exists has been determined in advance, the image conversion processing as the preprocessing may be switched in units of regions in a page rather than in units of pages. For example, when a region of a title of a bill exists in a region in an upper part of a page, for a predetermined region in an upper part of the first page, the processing contents may be the AI processing; and for the other region of the first page, the processing contents may be the other image conversion processing (for example, the dropout color processing) other than the AI processing.

In the exemplary embodiment described above, the AI processing is the example of the first image conversion processing, and the dropout color processing is the example of the second image conversion processing. The present disclosure is not limited thereto. The first image conversion processing and the second image conversion processing may be determined according to the character recognition accuracy and the processing speed. When plural AI processing are different in the character recognition accuracy and the processing speed, the first image conversion processing and the second image conversion processing may be determined (selected) from among the plural AI processing. Further, image conversion processing having a slower processing speed and higher character recognition accuracy than AI processing may be set as the first image conversion processing, and another AI processing may be set as the second image conversion processing.

In the above exemplary embodiment, the CPU serves as a processor. In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The processing executed by the server 14 according to the exemplary embodiment described above may be processing executed by software, processing executed by hardware, or processing by a combination of the software and the hardware. The processing executed by the server 14 may be stored in a storage medium as a program and distributed.

Further, the present disclosure is not limited to the above, and it is needless to say that various modifications other than the above may be implemented without departing from the scope of the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a processor configured to:
execute, as preprocessing prior to character recognition, image conversion processing for a document that is a target of the character recognition, the image conversion processing having been determined in advance for each of attributes in the document or for each of regions in the document, the regions having been determined in advance according to a document type; and
execute processing of executing the character recognition for the document that has been subjected to the image conversion processing to output a result of the character recognition.

2. The information processing device according to claim 1, wherein
the image conversion processing comprises
first image conversion processing for removing contents other than characters, and
second image conversion processing having (i) a character recognition accuracy lower than that of the first image conversion processing and a higher processing speed of removing the contents other than the characters than that of the first image conversion processing.

3. The information processing device according to claim 2, wherein
the first image conversion processing is image conversion processing using artificial intelligence trained in advance by machine learning.

4. The information processing device according to claim 3, wherein
the first image conversion processing comprises a plurality of different types of image conversion processing for objects, other than the characters, to be removed.

5. The information processing device according to claim 1, wherein
the processor is configured to execute the image conversion processing with changing a page order so as to process each image conversion processing.

6. The information processing device according to claim 2, wherein
the processor is configured to execute the image conversion processing with changing a page order so as to process each image conversion processing.

7. The information processing device according to claim 3, wherein
the processor is configured to execute the image conversion processing with changing a page order so as to process each image conversion processing.

8. The information processing device according to claim 4, wherein
the processor is configured to execute the image conversion processing with changing a page order so as to process each image conversion processing.

9. The information processing device according to claim 5, wherein
the processor is configured to execute the image conversion processing with changing the page order to a predetermined page order on a document-type basis.

10. The information processing device according to claim 6, wherein
the processor is configured to execute the image conversion processing with changing the page order to a predetermined page order on a document-type basis.

11. The information processing device according to claim 7, wherein
the processor is configured to execute the image conversion processing with changing the page order to a predetermined page order on a document-type basis.

12. The information processing device according to claim 8, wherein
the processor is configured to execute the image conversion processing with changing the page order to a predetermined page order on a document-type basis.

13. An information processing system comprising:
the information processing device according to claim 1; and
a request device configured to transmit a reading result obtained by reading the document to the information processing device to request character recognition.

14. An information processing system comprising:
the information processing device according to claim 2; and
a request device configured to transmit a reading result obtained by reading the document to the information processing device to request character recognition.

15. An information processing system comprising:
the information processing device according to claim 3; and
a request device configured to transmit a reading result obtained by reading the document to the information processing device to request character recognition.

16. An information processing system comprising:
the information processing device according to claim 4; and
a request device configured to transmit a reading result obtained by reading the document to the information processing device to request character recognition.

17. An information processing system comprising:
the information processing device according to claim 5; and
a request device configured to transmit a reading result obtained by reading the document to the information processing device to request character recognition.

18. An information processing system comprising:
the information processing device according to claim 6; and
a request device configured to transmit a reading result obtained by reading the document to the information processing device to request character recognition.

19. An information processing method comprising:
executing, as preprocessing prior to character recognition, image conversion processing for a document that is a target of the character recognition, the image conversion processing having been determined in advance for each of attributes in the document or for each of regions in the document, the regions having been determined in advance according to a document type; and
executing processing of executing the character recognition for the document that has been subjected to the image conversion processing to output a result of the character recognition.

20. A non-transitory computer readable medium storing a program that causes a computer to execute information processing, the information processing comprising:
executing, as preprocessing prior to character recognition, image conversion processing for a document that is a target of the character recognition, the image conversion processing having been determined in advance for each of attributes in the document or for each of regions in the document, the regions having been determined in advance according to a document type; and
executing processing of executing the character recognition for the document that has been subjected to the image conversion processing to output a result of the character recognition.
